(19) United States
(12) Patent Application Publication
(10) Pub. No.: US 2004/0106031 A1
(43) Pub. Date: Jun. 3, 2004

(54) METAL FOAM INTERCONNECT

(76) Inventors: Scott SHERMAN, Calgary (CA); Serene CHEUNG, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/604,499

(22) Filed: Jul. 25, 2003

Related U.S. Application Data
(60) Provisional application No. 60/319,428, filed on Jul. 25, 2002.

(51) Int. Cl. H01M 8/02

(52) U.S. Cl. 429/34; 429/38

(57) ABSTRACT

A fuel cell interconnect comprises a gas barrier plate and at least one metal foam flow field attached to the barrier plate. The plate may be corrugated. The interconnect may have a metal foam flow field attached to both sides of the barrier plate.

### CROSS REFERENCE TO RELATED APPLICATIONS

The present invention claims the priority of U.S. Provisional Patent Application No. 60/319,428 filed on Jul. 25, 2002, the contents of which are incorporated herein by reference.

### BACKGROUND OF INVENTION

The present invention relates to a novel interconnect plate for use in a solid oxide fuel cell.

In a fuel cell, oxidant and fuel are electrochemically reacted without burning to produce electricity directly. The reactants are supplied to the cell through manifolds and flow fields that direct reactants to the appropriate sides of a solid ceramic membrane that acts as an electrolyte. The membrane is coated with electrodes on both sides, and is impervious to the transfer of electrons, but allow ions of the oxidant to pass. Thus the streams of reactants are kept separate, but the electrons and ions from the reactants are allowed contact to effect the reaction. During operation, electrons are emitted at the fuel side electrode of the solid electrolyte membrane whereas electrons are absorbed at the oxygen side electrode thereby generating a potential difference between the two electrodes. The solid electrolyte membrane separates the reactants; it transfers the charge in the form of ions and, at the same time, prevents an electron short circuit between the two electrodes of the solid electrolyte. For this purpose, the solid electrolyte membrane needs to have a low conductivity for electrons but at the same time, a high conductivity for ions across the membrane.

Solid oxide fuel cells typically operate at high temperatures, typically over 800° C., which limits the selection of materials available for use as an interconnect that are able to withstand this temperature, and to simultaneously withstand an oxidizing environment on one side of the interconnect, and a partial reducing environment on the other. The material is also required to simultaneously maintain good electrical conductivity to collect the current generated by the cells. Most prior art interconnects have used ceramic materials and composites, however these materials demonstrate inferior electrical conductivity as compared to metals, and typically are not successful in withstanding both oxidizing and reducing environments simultaneously.

Ceramic materials also are expensive to purchase as raw materials, require moulding or other processing, and then firing or sintering. These steps are all labour intensive and require significant amounts of time to process. In addition, fine tolerances that are required in a solid oxide fuel cell stack are difficult to maintain when a green ceramic is sintered at the high temperatures required. Further, ceramic materials are brittle, and there can be significant losses during production due to handling and processing damage that occurs in the manufacture of the interconnect. Ceramic materials are also vibration and shock intolerant, which makes them unsuitable for applications where these factors are present, such as in automobiles.

Metallic interconnects which are machined from solid metal plates are known but are difficult to manufacture and as a result are expensive. There have been attempts to form metallic interconnects by bonding stacked metal plates together however such attempts have not been successful because of leaks forming between the metal plates and their inability to withstand the operating temperatures of solid oxide fuel cells. For example, U.S. Pat. No. 3,484,298 discloses a laminated electrode backing plate which is laminated using adhesives or other bonding agents.

Accordingly, there is a need in the art for a metallic interconnect which may mitigate the disadvantages of the prior art.

### SUMMARY OF INVENTION

The present invention is directed to a novel interconnect comprising metal foam. Prior art metallic interconnects typically comprise a solid barrier plate which separates an air flow field on one side and a fuel flow field on the other, together with internal manifolding to direct air and fuel gas flows into and out of the interconnect.

In the present invention, in one aspect, the interconnect plate comprises a barrier plate having two major surfaces and a metal foam layer attached to one major surface which serves as the fuel gas flow field. In one embodiment, a second metal foam layer attached to the other major surface which serves as the oxidant gas flow field. The first and second metal foam layers are attached to the barrier plate in an electrically conductive manner, such as by welding or brazing, so that the interconnect is entirely electrically conductive. Alternatively, the foam layers may be formed directly on the barrier plate using a slurry foaming technique or other well known metal foaming techniques. A suitable slurry foaming technique is described in U.S. Pat. No. 6,117,592, the contents of which are incorporated by reference herein.

In another embodiment, the barrier plate may have a metal foam layer attached to one major surface only and may be ribbed. The metal foam layer serves as the fuel gas flow field while the ribbed plate surface serves as the oxidant gas flow field.

### BRIEF DESCRIPTION OF DRAWINGS

The invention will now be described by way of an exemplary embodiment with reference to the accompanying simplified, diagrammatic, not-to-scale drawings. In the drawings:

FIG. 1 shows a cross-sectional representation of one embodiment of the interconnect.

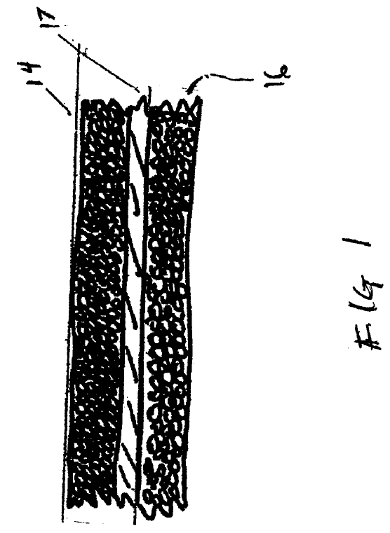

FIG. 2 shows a perspective view of one embodiment of the interconnect.

FIG. 3 shows a cross-sectional representation of an alternative embodiment.

FIG. 4 shows a perspective view of the embodiment of FIG. 2, folded and ready for assembly.

FIG. 5 shows an exploded view of interconnects assembled with solid oxide fuel cells.

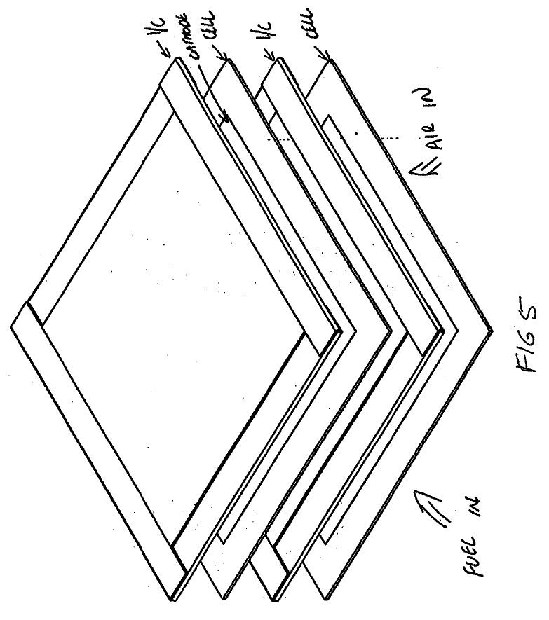

### DETAILED DESCRIPTION

The present invention provides for a bipolar plate or interconnect for use in a solid oxide fuel cell. In general terms, the interconnect comprises a central gas separator plate (12) with an air/oxidant gas flow field (14) and a fuel gas flow field (16). The gas separator plate (12) is impervious to gas and preferably comprises a material with the same or similar coefficient of thermal expansion as one or both of the flow fields.

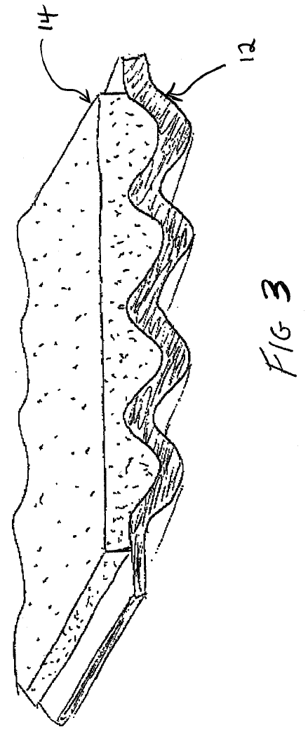

The separator plate (12) should preferably be fairly rigid although some flexibility may be tolerated and in fact may be necessary for use with fuel cells that are not truly planar. In one embodiment, the separator plate is only about 0.010″ thick and is therefore fairly flexible. This permits the interconnect to conform to slightly warped fuel cells or to conform to distortions during heat cycling of the stack. As well, the plate (12) may be flat or it may be ribbed. In one embodiment, the plate (12) has been stamped to form ribbed corrugations, as shown in FIG. 3. In one embodiment, one or both of the flow fields (14, 16) are comprised of a highly porous metal foam. Preferred metal foams are greater than about 80% porous, more preferred are about 90% porous and most preferred are about 95% porous. High porosity permits gas flow with a minimal resistance or pressure drop through the interconnect. However, increased porosity may introduce two disadvantages being decreased electrical conductivity and low mechanical strength. A preferred foam porosity will have adequate mechanical strength, electrical conductivity and permit adequate gas flow through the interconnect.

The metal foams may be formed by any known technique for producing metal foams, such as metal plating a resin sponge followed by heat treatment to burn the sponge. In one preferred embodiment, the metal foams are formed using a slurry foaming technique as described in U.S. Pat. Nos. 5,848,351 and 6,117,592, the contents of which are incorporated herein by reference. The foamable slurry may be coated on both sides of the separator plate prior to foaming and sintering or the separator plate may be extruded with the metal foam.

The metal foam used for the fuel side flow field (14) is preferably formed from nickel. Nickel is not preferred for the metal foam used for the air flow field (16) as it is readily oxidized at fuel cell operating temperatures. Therefore, preferred metals for use in the air flow field (16) include Haynes H230, stainless steel, Hastaloy, Inconel or other oxidation resistant alloys.

In an alternative embodiment, as shown in FIG. 3, only the fuel side flow field (14) is comprised of a metal foam. The flow field on the cathode side of the interconnect is created by stamping the separator plate into a ribbed or corrugated pattern. The foam fills in the ribs on the fuel gas side while the ribs contact the adjacent cathode on the air side. A cathode contact paste which dries or sinters to form a thin porous ceramic layer may be used to facilitate electrical contact between the interconnect and the cathode. There is improved contact between the plate and foam as a result of the increased contact area.

The flow field metal foams are bonded to the separator plate, either during the foam creation process, or by welding or brazing. In any event, the bond should preferably be electrically conductive as the resulting interconnect plate must be electrically conductive. It is preferred to minimize any electrical resistance through the interconnect. The bonding of the foams to the separator plate eliminates a connection which may otherwise be susceptible to corrosion and electrical resistance. The interconnect thus formed provides more uniform contact with the ceramic cell electrode surfaces.

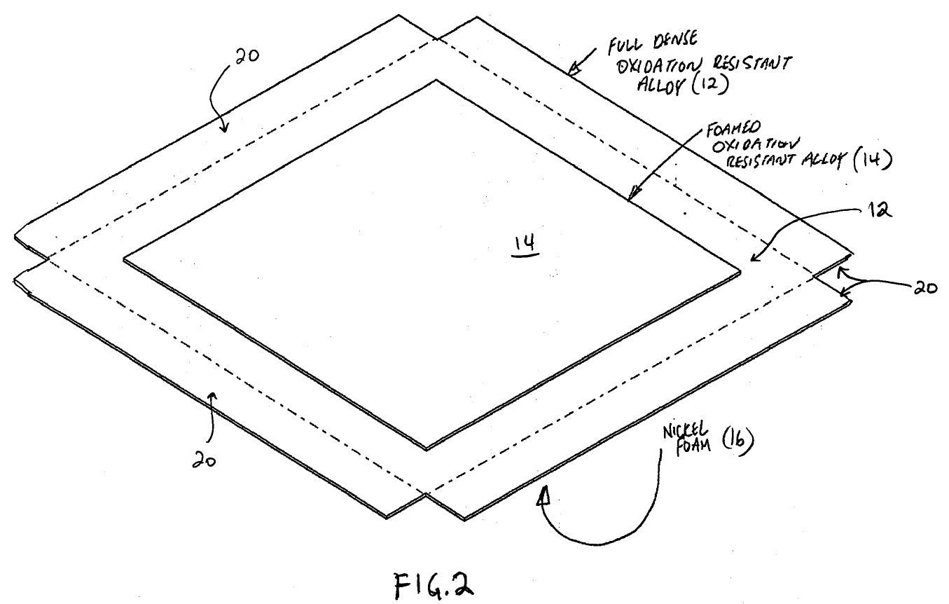

In one embodiment, the gas separator plate extends beyond the area of the foam flow fields and may include tabs (20) as shown in FIG. 2. The tabs (20) may be folded to create parallel flow guides (22) on one side of the interconnect and parallel flow guides (24) on the other side which are perpendicular to first set of flow guides (22). Gas may then flow between the flow guides on either side of the interconnect.

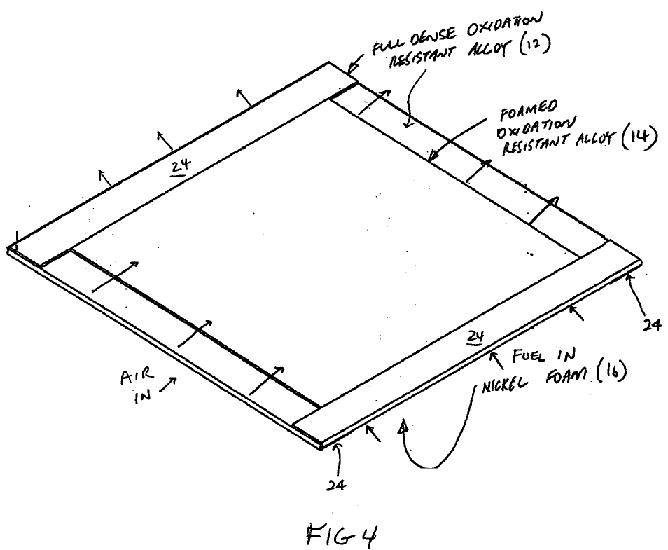

When assembled into a fuel cell stack, as shown in FIG. 4, the interconnect (10) is placed between two adjacent ceramic cells with each flow field in intimate contact with an electrode of the ceramic cells. The cells and interconnects are stacked in conventional fashion to create a fuel cell stack. One skilled in the art will readily appreciate that the air and fuel gas flows must be manifolded separately and the fuel cell stack carefully sealed to prevent the two gas flows from mixing. The fuel cell stack shown is configured to be fitted with external manifolds.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

1. A fuel cell interconnect comprising a gas barrier plate which is impervious to gas and at least one porous metal layer.

2. The interconnect of claim 1 comprising a central gas barrier plate disposed between a first and second porous metal layer.

3. The interconnect of claim 1 wherein the gas barrier plate is corrugated.

4. The interconnect of claim 3 comprising a single porous metal layer.

5. The interconnect of claim 1 wherein the gas barrier plate comprises a material selected from the group consisting of stainless steel, Hastaloy alloys and Inconel alloys.

6. The interconnect of claim 1 wherein the first outer metal foam layer comprises a nickel foam bonded to the gas separator layer.

7. The interconnect of claim 4 wherein the second outer porous metal layer comprises a foam comprising Haynes H230.

8. The interconnect of claim 1 wherein the porous metal layers are bonded to the gas barrier plate in an electrically conductive manner.

9. The interconnect of claim 6 wherein the porous metal layers are bonded to the gas barrier plate by welding or brazing.

10. The interconnect of claim 1 wherein the at least one porous metal layer comprises a metal foam formed by slurry foaming.
